(19) United States
(12) Patent Application Publication
(10) Pub. No.: US 2007/0109264 A1
(43) Pub. Date: May 17, 2007

(54) Letter inputting system and method using analog joystick controller

(75) Inventors: Hye Sun Kim, Taejon (KR); Beom Ryeol Lee, Taejon (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/442,201

(22) Filed: May 30, 2006

(30) Foreign Application Priority Data
Nov. 16, 2005 (KR) 2005-0109779

(51) Int. Cl. G09G 5/08

(52) U.S. Cl. 345/161

(57) ABSTRACT

There are provided a letter inputting system and method capable of effectively and rapidly inputting a letter using an analog joystick controller for an existing consol game. The letter inputting method includes the steps of: inscribing a character string by controlling an input pointer using an analog joystick controller; recognizing whether or not the inputted character string is a gesture at a letter/gesture recognition unit; and detecting the inputted character string as a resultant character string if the recognized characteristic string is not the gesture, and converting the inputted character string into a character string matched with the gesture so as to detect the converted character string as the resultant character string after searching the gesture list if the inputted character string is the gesture.

### BACKGROUND OF THE INVENTION

1. Field of the Invention

The present invention relates to a letter inputting system and method using an analog joystick controller, and more particularly, to a system for inputting a letter on a game screen by automatically recognizing a character string, which is inputted as if it is drawn on the screen using an analog joystick controller, by means of a letter/gesture recognition technology, and a letter inputting method using the same.

2. Description of the Related Art

Conventionally, one letter of alphabet, an arabic numeral, or a symbol is inputted through only one keypress in a game system such as a portable game machine and a home television game machine. Meanwhile, the letter input in an existing console game is an intricate operation that letters should be inputted after being directly selected one by one from a virtual keyboard of a screen. That is, the letters of the virtual keyboard are distributed and arranged in a plurality of cells so that the letter can be selected rapidly by reducing the number of the commands using a controller such as a game controller.

The reason that the conventional letter inputting method has bee used yet despite the inconvenience thereof, is that it is simple in embodying the method, and further, it is thought up to date that the letter input is not important in the console game because most of the console games are played in off-line so that the letter input is only needed when storing game situations in the beginning or in the end of the game.

The letter inputting system widely used in the current console game is a system that a virtual keyboard is displayed on the screen and the letters are inputted after being selected one by one. As described above, since most of the console games are played in off-line up to date and thus there are few cases of inputting the letter during the game, the conventional letter inputting system may can be used without any feeling of inconvenience. However, as an on-line console game becomes popular nowadays, the importance of the letter input begins to increase due to a chatting, etc, while playing the console game. Accordingly, the system for inputting the letter one by one with the virtual keyboard cannot be used for the on-line console game any longer.

Therefore, to keep pace with the tendency of the on-line console game's being popular, a method for inputting a letter with ease while playing the game has been developed. However, this method is not so much different from the aforementioned conventional method for inputting the letter after selecting the letter on the screen. For instance, a method for arranging a character string in a type of a tree has been proposed in order to input the letter within a shorter time using the virtual keyboard on the screen. In addition, in order to accord with a quick game situation among various existing console games, there has been another letter inputting method such that a desired character string is inputted in advance and this character string is displayed on the screen during the game so that one character string is selected and inputted. However, all the above methods have a limitation in inputting a desired letter by a user.

As the on-line console game has been popular and a game interfaced with other devices such as a personal computer (PC), a mobile phone, or the like, has been in the limelight as a future generation game recently, the expediency of the letter input is an object which should be achieved in the console game.

### SUMMARY OF THE INVENTION

Accordingly, the present invention is directed to a letter inputting system and method using an analog joystick controller, which substantially obviates one or more problems due to limitations and disadvantages of the related art.

It is an object of the present invention to provide a system for inputting a letter on a game screen by automatically recognizing a character string, which is inputted as if it is drawn on the screen using an analog joystick controller which is freely movable in analog fashion, by means of a letter/gesture recognition technology, and a letter inputting method using the same.

It is another object of the present invention to provide a system and method for inscribing a desired letter or gesture without any limitation by controlling an input pointer of a screen like controlling a pointer using a mouse of a personal computer as an analog joystick controller.

The analog joystick controller has an advantage that a user can rotate and move it in all the directions. By using this, when the user draws a letter on a screen by moving the input pointer of the screen in a desired direction, a letter recognition system recognizes this automatically and then input it. Although the method itself for inscribing all the letters using the analog joystick is an advanced method in comparison with a prior art virtual keyboard on the screen, there may be employed another inventive method for converting a gesture into a letter by drawing the gesture simply and shortly in advance for a user who is not experienced in using the joystick. That is, if the user defines predetermined gestures in advance, the letter recognition system converts the inputted gesture into a desired character string. Resultingly, since a long sentence is not inputted fully but only a short gesture can be inputted instead of it, the input of the long sentence during the game can be completed rapidly.

Therefore, the user can input the character string rapidly with ease using the analog joystick controller while playing the console game. In addition, it is possible to overcome several problems of the prior art method such as an intricacy of selecting a letter, a limitation of the letter which can be inputted, lots of time expense, or the like.

Furthermore, because the existing console game is still used, a special apparatus is not needed in the present invention. Also, since the inputted letter or gesture is automatically recognized by a letter/gesture recognition system, it is possible to enhance an inconvenient prior art letter inputting method with ease.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a letter inputting system including: an analog joystick controller inscribing letter/gesture by controlling an input pointer; a console including a letter/gesture recognition system for recognizing the inputted letter/gesture to, detect a resultant character string; and a display unit for displaying the detected resultant characteristic string.

In addition, the letter/gesture recognition system includes: a letter/gesture recognition unit for recognizing whether the inputted characteristic string is a gesture or not; and a memory in which a gesture list is stored, the gesture list being made out in advance by matching a specific gesture with a character string.

Furthermore, the letter/gesture recognition unit detects the inputted character string as the resultant character string if the inputted characteristic string is not the gesture, and the letter/gesture recognition unit converts the inputted character string into a character string matched with the gesture so as to detect the converted character string as the resultant character string after searching the gesture list if the inputted character string is the gesture.

Also, the gesture list is made up through a pretreatment operation that a gesture is inscribed using the analog joystick controller, and a character string corresponding to the inputted gesture is inputted and matched with the inputted gesture, before a game starts being played.

In another aspect of the present invention, there is provided a letter inputting method including the steps of: inscribing a character string by controlling an input pointer using an analog joystick controller; recognizing whether or not the inputted character string is a gesture at a letter/gesture recognition unit; and detecting the inputted character string as a resultant character string if the recognized characteristic string is not the gesture, and converting the inputted character string into a character string matched with the gesture so as to detect the converted character string as the resultant character string after searching the gesture list if the inputted character string is the gesture.

Due to characteristics of the game, it is very ineffective for inputting frequently used character strings repeatedly in every required moment. If a long sentence, which may be taken for a long time, is inputted one by one at every required occasion, it may disturb a flow of the game. Thus, if inputting the frequently used character strings in advance and matching them with specific gestures, only short gesture enables the long sentence to be inputted rapidly.

The operation that the desired character string is matched with the specific gesture is a pretreatment operation which is performed in advance before playing the game, wherein the gesture is pre-defined by a user. That is, this operation is done by drawing the specific gesture using the analog joystick controller by executing a gesture matching system before playing the game, and matching the desired character string with the specific gesture by the user.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram of a letter inputting system according to the present invention;

FIG. 2 is a detail block diagram illustrating a letter/gesture recognition system of FIG. 1;

FIG. 3 is an exemplary diagram illustrating a letter inputting system using an analog joystick controller according to the present invention; and

FIG. 4 is a flowchart illustrating an operation of the letter inputting system according to the present invention.

### DETAILED DESCRIPTION OF THE INVENTION

Reference will now be made in detail to the preferred embodiments of the present invention, examples of which are illustrated in the accompanying drawings.

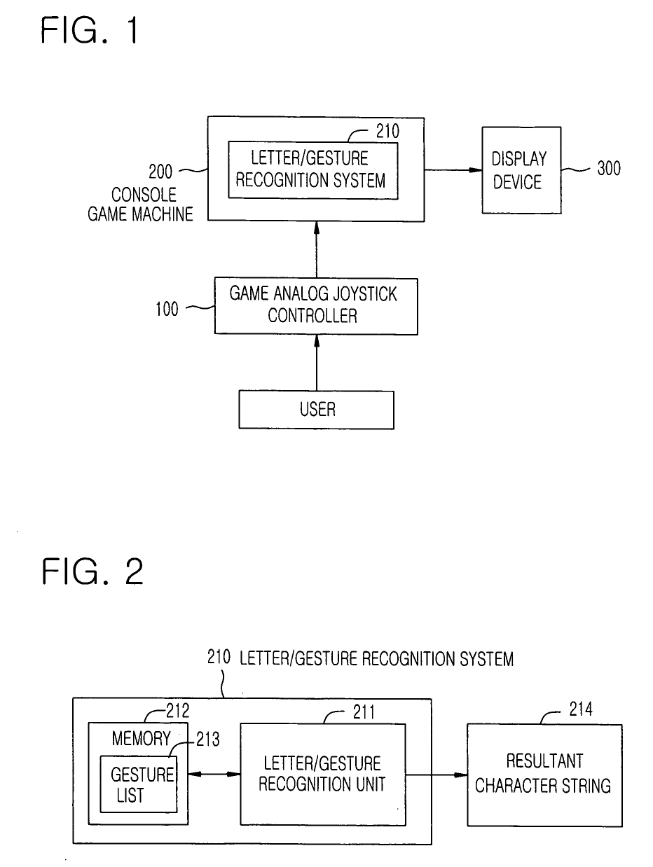

FIG. 1 is a block diagram of a letter inputting system according to the present invention. The letter inputting system includes a game analog joystick controller 100, a console game machine 200 having a letter/gesture recognition system 210, and a display device 300.

If a user inscribes a character string by controlling an input pointer of a screen using the analog joystick controller 100, the letter/gesture recognition system 210 in the console game machine 200 determines whether the inputted character string is a letter or a gesture, and recognizes it. The resultant character string is transferred to the display device 300.

Such a letter/gesture recognition system 210 may be implemented in a middle ware fashion mounted in the existing console game machine or in an application software fashion incorporated in every game which requires a letter input.

FIG. 2 is a detail block diagram illustrating the letter/gesture recognition system 210 of the letter inputting system of FIG. 1. The letter/gesture recognition system 210 is configured with a letter/gesture recognition unit 211, and a memory 212 in which a gesture list 213 is stored. The letter/gesture recognition unit 211 determines whether the character string inputted by a user is a letter or a gesture, and recognizes the inputted character string. Herein, the gesture list 213 is a list in which a predetermined character string is matched with a specific gesture and it is stored in advance before a user starts playing the game.

If the character string recognized at the letter/gesture recognition unit 211 is a letter, the letter/gesture recognition unit 211 outputs the inputted character string on the screen as it is. On the contrary, if the recognized character string is a gesture, the letter/gesture recognition unit 211 searches the gesture list 213 stored in the memory 212 and detects a character string matched with the inputted gesture.

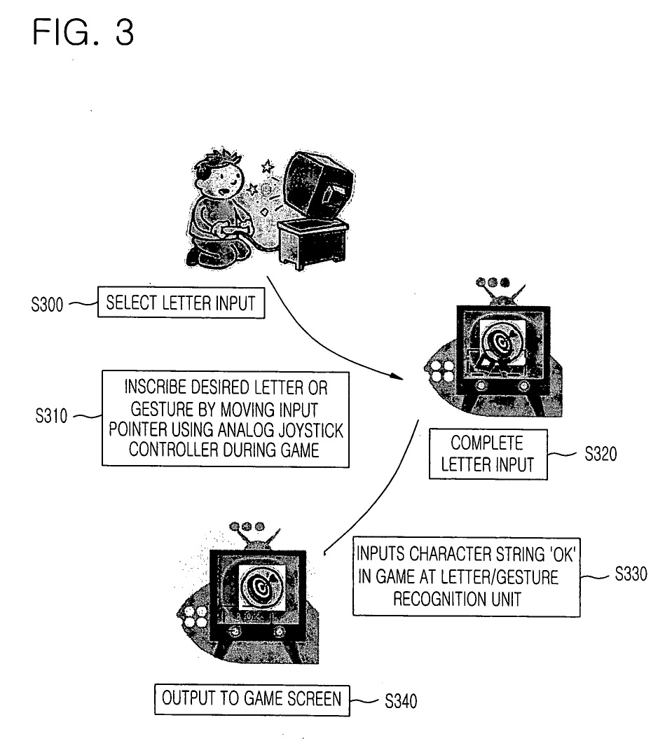

FIG. 3 illustrates a procedure of inscribing a desired character string or a gesture on a screen by moving an input pointer of a screen using the analog joystick controller 100. After selecting the letter input while the user playing the game (S300), the input pointer of the screen is controlled by moving the analog joystick controller 100 in every direction so that a character string ‘OK’ is inscribed (S310). After completing inputting the character string (S320), the inputted character string ‘OK’ is automatically recognized at the letter/gesture recognition unit 211 (S330). Thereafter, it is recognized as a letter ‘OK’ and then is outputted on the game screen as it is (S340).

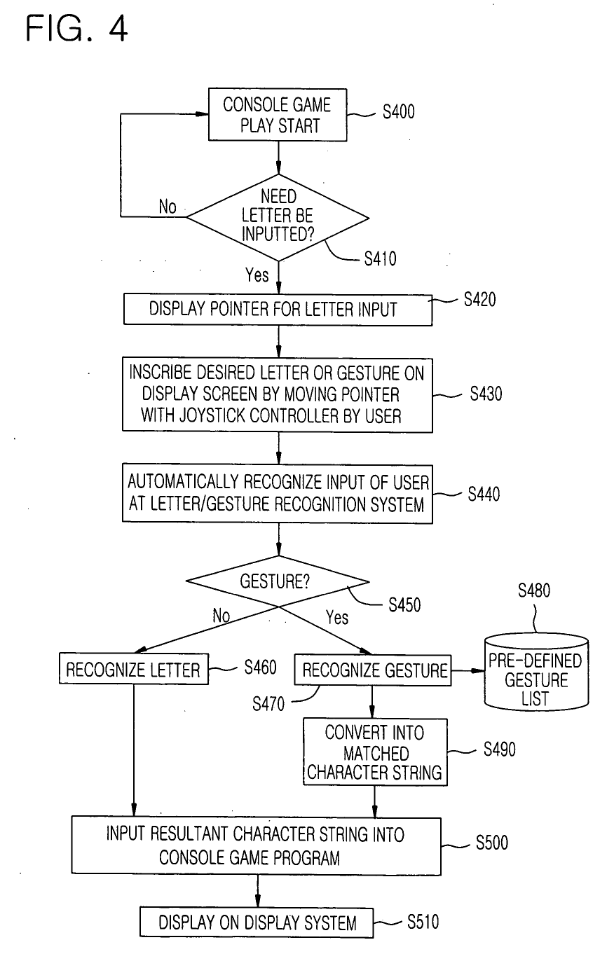

FIG. 4 illustrates an operational flow of the letter inputting system according to the present invention. Prior to illustration of the operation of the letter inputting system, it should be premised on several assumptions. First, it is assumed that the input pointer should be moved freely on the screen according to the movement of the analog joystick controller like a mouse pointer of a PC system. Second, it is assumed that a gesture is pre-defined by a user in advance so that a desired character string has been matched with a specific gesture before the user starts playing the game.

After performing a pretreatment operation that a user matches the desired character string with the specific gesture in advance, a game starts being played (S400). Thereafter, the user selects whether the letter needs to be inputted or not (S410). After the letter input is selected, a pointer for the letter input is displayed (S420). Afterwards, the user inscribes a desired letter or a gesture on a display screen by moving the input point of the screen using the analog joystick controller 100 (S430). After completing the input, the letter/gesture recognition unit 211 automatically recognizes the letter or the gesture inputted by the user (S440).

The letter/gesture recognition unit 211 determines whether or not the inputted letter is a gesture (S450), and recognizes as it is, if the inputted letter is a letter (S460). Thereafter, the inputted letter is transferred as a resultant character string to a console game program (S500), and then is displayed on a display system (S510). If the recognized letter is a gesture (S470), the gesture list 213 which is pre-defined in advance, is searched (S480). Thereafter, an inputted gesture is converted into a matched character string (S490). Afterwards, the converted resultant character string 214 is inputted into the console game program (S500) and then, is displayed on the display system (S510).

The letter or gesture recognized through this procedure is used as an input of the game. At this time, the recognized gesture is searched in the gesture list 213 to be converted into the pre-defined character string. Post operations performed henceforth are identical to those of inputting the letter in other platform games.

As described above, the letter inputting system using the analog joystick controller according to the present invention, is an essential technology to expand the consol game and further keep pace with the tendency of the one-line console game's being popular. Since a letter/gesture recognition technology which has been developed for a long time is applied to the inventive letter inputting method of the console game, the present invention provides an advantage of very high stability in recognizing the letter. In addition, the analog joystick controller which has been used in the existing console game machine is still used as an input device, it is unnecessary to employ an additional device. Therefore, the present invention is excellent in implementing and commercializing the on-line console game.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A letter inputting system comprising:
an analog joystick controller inscribing letter/gesture by controlling an input pointer;
a console including a letter/gesture recognition system for recognizing the inputted letter/gesture to detect a resultant character string; and
a display unit for displaying the detected resultant characteristic string.

2. The letter inputting system of claim 1, wherein the letter/gesture recognition system comprises:
a letter/gesture recognition unit for recognizing whether the inputted characteristic string is a gesture or not; and
a memory in which a gesture list is stored, the gesture list being made out in advance by matching a specific gesture with a character string.

3. The letter inputting system of claim 2, wherein the letter/gesture recognition unit detects the inputted character string as the resultant character string if the inputted characteristic string is not the gesture, and
the letter/gesture recognition unit converts the inputted character string into a character string matched with the gesture so as to detect the converted character string as the resultant character string after searching the gesture list if the inputted character string is the gesture.

4. The letter inputting system of claim 2, wherein the gesture list is made up through a pretreatment operation that a gesture is inscribed using the analog joystick controller, and a character string corresponding to the inputted gesture is inputted and matched with the inputted gesture, before a game starts being played.

5. A letter inputting method comprising the steps of:
inscribing a character string by controlling an input pointer using an analog joystick controller;
recognizing whether or not the inputted character string is a gesture at a letter/gesture recognition unit; and
detecting the inputted character string as a resultant character string if the recognized characteristic string is not the gesture, and converting the inputted character string into a character string matched with the gesture so as to detect the converted character string as the resultant character string after searching the gesture list if the inputted character string is the gesture.

6. The method of claim 5, wherein the gesture list is made up in advance by matching a specific gesture with an arbitrary character string by a user.
